(19) United States
(12) Patent Application Publication
(10) Pub. No.: US 2005/0199654 A1
(43) Pub. Date: Sep. 15, 2005

(54) Tube with self-closing mechanism for liquid container

(75) Inventor: Thorkild Andersen, Hadsten (DK)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: DISOP NORDIC HOLDING APS, Hadsten (DK)

(21) Appl. No.: 10/510,682

(22) PCT Filed: Apr. 10, 2003
(86) PCT No.: PCT/DK03/00241

§ 371 Date: May 31, 2005

(30) Foreign Application Priority Data
Apr. 10, 2002 (DK) PA 2002 00536
Sep. 2, 2002 (DK) PA 200201289

(51) Int. Cl. G01F 11/42

(52) U.S. Cl. 222/190; 222/321.7; 222/380; 222/494

(57) ABSTRACT

The invention relates to a tube for application for a container with a built-in pump, in which the tube possesses an internal cross section of an inside for flow of a liquid, an external cross section of the tube, which is larger than the internal cross section, a first end with a first opening for intake of the liquid, and where the first end encompasses fastening means for fastening of the tube on the container and another end with an opening part encompassing another opening for discharge of the liquid. The other end additionally encompasses a barrier part, where the barrier part edges towards the opening parts, so that it blocks for the other opening. At least the barrier part of the opening part is made from an elastic material, so that the liquid can be pressed out through the other mentioned opening passing the barrier part after a deformation of at least the barrier part or the opening part. In this way a closing mechanism is obtained, which prevents contamination with microorganisms and prevents impurities from penetrating into the tube of the container. The closing mechanism may be manufactured economically. Besides the opportunity is obtained for adjusting the velocity of the pumped out liquid as well as for pumping out the liquid in the form of a drop, each time the pump is activated.

### FIELD OF THE INVENTION

The invention relates to a tube as described in the initial section of claim 1. Furthermore the invention relates to the tube according to claim 1 in combination with a container with a built-in pump as described in the initial section of claim 10.

### BACKGROUND ART

Within the pharmaceutical range many preparations are available as liquids. These preparations are in many cases stored in small or medium-sized containers, which are besides equipped with a tube which is suitable for pressing the preparation out of the container. In many cases the container is additionally provided with a built-in pump, typically built together with the tube, which is activated by hand force. In order to avoid undesired development of bacteria in the container a preservative may be added to the preparation. It is, however, desirable for certain types of preparations, as for instance eye drops, to avoid the addition of preservatives, as they may cause allergic reactions. In these cases a container with a pump is utilized, which prevents reflux of the preparation, so that impurities cannot be sucked back into the container. Several types of preservative-free pumps are available, which are characterized by the fact that bacteria cannot penetrate into the container. The weak spot is, however, the area from the valve of the pump and onwards to the spot where the drop comes out of the tube (the tip). In this case different manufacturers have chosen different solutions, which could for instance be represented by embedding of silver ions in the plastic in the area in question or mechanical valves preventing the particles from penetrating. By applying mechanical valves a remaining area will still exist (from the mechanical valve and onwards to the spot where the drop comes out of the tube), which is exposed to impurities. Besides the mechanical valve constitutes a cost-increasing element. Correspondingly embedding of silver ions is a cost-increasing process.

### SUMMARY OF THE INVENTION

It is the objective of the invention to provide a self-closing mechanism, which prevents contamination with microorganisms, and which prevents impurities from penetrating into the tube in a container, and which concurrently may be manufactured economically.

This is, as stated, obtained in the characterizing part of claim 1 and 10.

Hereby a closing mechanism is obtained, which prevents contamination with microorganisms, and which prevents impurities from penetrating into the tube of a container. The closing mechanism may at the same time be manufactured economically. Besides the possibility is obtained of adjusting the velocity of the liquid, which is pumped out to a desired quantity. Finally pumping out of the liquid is enabled by way of a drop each time the pump is activated.

By a tube a tube intended for a liquid container should be construed. The tube may be cylindrically formed, but other geometries can also be utilized. For instance triangular tubes, quadrangular tubes, or multiangular tubes (from five and onwards). The tube may be straight or bent one or several times (for instance V-like shape, N-like shape, W-like shape etc.). The bending of the tube may besides follow a soft curve (for instance U-like shape or S-like shape). The tube can be provided with “concertina-bending”, so that the tube may be turned by a user. The tube may besides be provided with a sharpening at the mouth of the tube.

When the opening part in the other end contains a narrowing from the internal cross section of the inside to the opening cross section of the other opening across an axial distance longitudinally in relation to the tube, establishment of a closing mechanism is enabled by placing a bar of an elastic material in the tube, where the bar edges towards the narrowing. As the narrowing takes place over an axial distance longitudinally in relation to the tube, it is besides possible to focus a liquid which is pumped out and to determine the velocity of the liquid which is pumped out.

In case the narrowing is arranged proportionally with the axial distance, and in case a straight line with the narrowing has an angle (α) longitudinally to the tube, where α is less than 90 degrees, a particularly simple geometry is obtained, which facilitates the focusing of the liquid which is pumped out and eases the determination of the velocity of the liquid which is pumped out.

In case the opening part at the other end comprises a sharpening of the tube to an edge cross section of the narrowing, where the edge cross section is provided with an area which is smaller than that of the external cross section of the tube, and in which the edge cross section is provided with an area, which is larger than the area of the opening cross section of the other opening, a tube is obtained which prevents drops from adhering to the end of the tube after completion of the pumping of the liquid through the tube.

In case the flexible material is provided with resistant characteristics towards the liquid, it is avoided that the materials of the closing mechanism may combine with the liquid in the container or are solely dissolved in the liquid. This is of particular importance in case of pharmaceutical products.

In case the opening part in the other end comprises a barrier of silver ions and/or nanosilver particles, development of bacteria at the tip of the tube is prevented.

In case the tube comprises a protective cap adapted for fitting on the tube, where the protective cap is provided with covering means for covering of the other opening, the penetration of impurities to the tip of the tube is prevented.

In case the covering means comprise a barrier of silver ions and/or nanosilver particles development of bacteria in the protective cap is prevented, and thus also that development of bacteria may access the tip of the tube.

### BRIEF DESCRIPTION OF THE DRAWINGS

The invention will be described in further detail under reference to the enclosed figures, where

FIG. 1a illustrates a tube seen from the side according to the present invention, and

FIG. 1b illustrates a tube seen from the end according to the present invention, and

FIG. 2 illustrates the fastening means of a container for a tube according to the present invention, and

FIG. 3 illustrates a container with a tube according to the present invention and a protective cap, and

FIG. 4 illustrates a protective cap, and

FIG. 5 illustrates another embodiment of a tube, and

FIG. 6 illustrates a third embodiment of a tube, and

FIG. 7 illustrates a fourth embodiment of a tube, and

FIG. 8 illustrates a container with a tube according to the present invention and with an alternative protective cap, and

FIG. 9a illustrates an alternative embodiment of the other end of the tube seen from the side, and

FIG. 9b illustrates the tube from FIG. 9a seen from the end, where no cap is arranged, and

FIGS. 10a and 10b illustrate an embodiment of a core, and

FIG. 11 illustrates another embodiment of the other end of the tube seen from the side, and

### DETAILED DESCRIPTION OF PREFERRED EMBODIMENTS OF THE INVENTION

In a preferred embodiment according to the invention the tube and container are used for pharmaceuticals and ophthalmic compositions, e.g artificial tears and compositions comprising hyaluronic acid used at cataract surgery.

In another preferred embodiment of the present invention the tube and container according to the invention give, when applied with ophthalmic compositions, a drop that is smaller than 50 μl, more preferably 15-30 μl, most preferably 15 μl.

In yet another preferred embodiment the tube and container according to the invention, when used with ophthalmic compositions, are used with the container vertically while dispensing the pharmaceutical, so that the drop comes into the eye in a horizontal direction. This makes the handling much easier, since the person using the container according to the invention can dispense the fluid with the head in an upright position and at the same time look into a mirror.

When using a container with the tube according to the present invention the tube is preferably held 0.5-1.5 cm, more preferably 1 cm, from the eye while dispensing an ophthalmic pharmaceutical.

In another preferred embodiment the tube is a silicone tube with a degree of hardness of 40-110 Shore. The degree of hardness of the tube may be varied depending on the viscosity of the liquid to be pumped out from the container via the tube. However, if it is not enough to vary the degree of hardness of the silicone, the hole in the tube may also be modified. A larger hole in the tube gives a slower velocity, with which the liquid comes out from the tube.

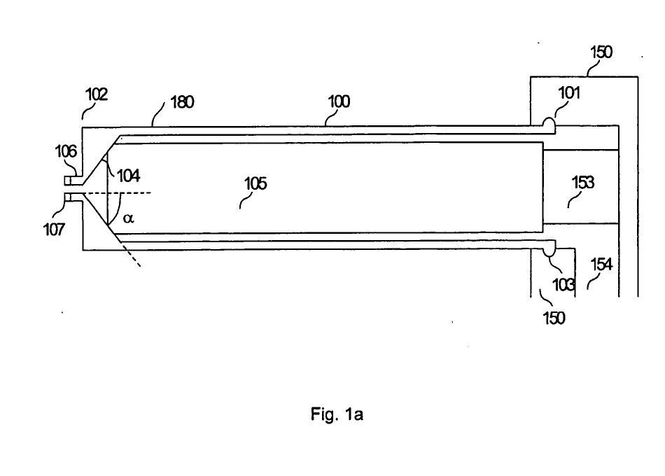

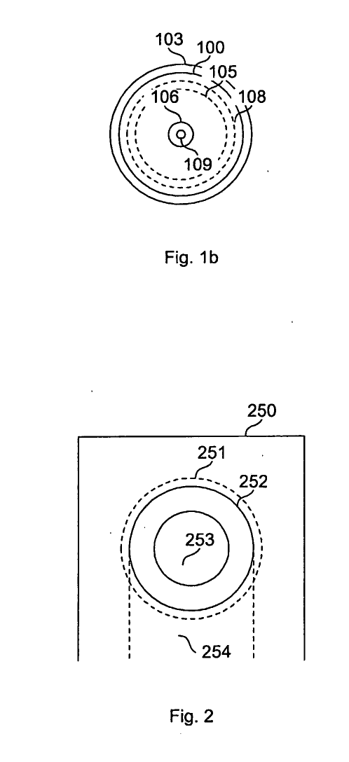

In FIG. 1 a tube 100 is illustrated seen from the side according to the present invention. The tube 100 comprises a first end 101 for intake of a liquid and another end 102 for discharge of the liquid. The first end 101 of the tube is provided with fastening means 103 by way of a collar, by the aid of which the tube 100 can be fastened on a container 150. The other end 102 of the tube comprises an opening part 180, which is provided with a narrowing 104, towards which a bar 105 of an elastic material edges. A straight line parallel to the narrowing 104 possesses an angle α longitudinally to the tube. The bar 105 is held in position by means of a pin 153. The pin 153 forms part of the container 150. The opening part 180 in the other end 102 of the tube is besides provided with a sharpening 106. On sharpening 106 a barrier of silver ions and/or nanosilver particles is cast in. In case a pump (not illustrated), which is built into the container 150, is activated, the liquid is pressed up through a cavity 154, passing the pin 153 and out into the tube 100 into the clearance between the tube 100 and the bar 105. Where the bar 105 edges towards the narrowing 104, the liquid pressure squeezes together the bar 105 cross sectionally and/or in a longitudinal direction, so that the liquid can pass further on to the sharpening 106. When the pump is thereafter deactivated, the bar 105 will again edge towards the narrowing 104, thus blocking for the liquid flow. As the blocking takes place in the (outermost) end of the opening part 180 in the other end 102 of the tube 100, the area which may be subject to development of bacteria is most limited, and this development of bacteria is remedied by the barrier 107 of silver ions and/or nanosilver particles. The narrowing 104 may besides be coated with a barrier of silver ions and/or nanosilver particles. It is besides recognized that the tube 100 is provided with a cylindrical shape. The invention is, however, in no way limited to cylindrical tubes. All geometries may be utilized, for instance, triangular tubes, quadrangular tubes or multiangular tubes (from five and onwards). The tube may besides be bent one or several times (for instance V-like shape, N-like shape, or W-like shape), but may also follow a soft curve (for instance S-like shape).

The idea is to arrange a bar of a non-porous, elastic material inside the tube, so that it fills the tube longitudinally and concurrently possesses a diameter somewhat less than the internal diameter of the tube. The tube has been formed, so that at the opening a non-vertical surface in relation to the longitude of the tube is formed (that is an internal narrowing, for instance in the shape of a cone). This internal narrowing has the purpose of keeping the elastic bar in place and together with the elastic bar to form a closing mechanism. The angle (a) and the elasticity of the bar will together with the viscosity of the preparation determine the velocity, with which the preparation leaves the tube. The closing mechanism may accordingly be adapted to a given velocity for a given preparation by determination of the angle (a) of the narrowing and by determination of the elasticity of the bar. The closing mechanism functions by means of the force, with the aid of which the liquid leaves the valve inside the pump. The pressure from the liquid will compress the elastic material cross-sectionally and/or in a longitudinal direction, and the liquid will be pressed out of the opening of the tube. When the pressure falls again, the elastic material will revert to its original shape and thereby close the hole. The closing mechanism applies an elastic material, which will resist the ability of the microorganisms to adhere to the surface. The material can besides be provided with cast-in, active silver ions and/or nanosilver particles for greater safety.

In FIG. 1b a tube 100 is seen from the end according to the present invention. The tube 100 illustrated in FIG. 1b is the same tube, which is illustrated seen from the side in FIG. 1a. The cross section of the tube 100 constitutes an external cross section. The tube 100 has en inside 108 (illustrated with a dotted line). The cross section of the inside 108 constitutes an internal cross section. The tube 100 contains a bar 105 (illustrated with a dotted line) of an elastic material. The bar 105 and a narrowing of the tube 100 will together form a valve. The tube 100 possesses another opening 109. The cross section of the other opening 109 constitutes an opening cross section. The tube 100 is besides provided with a sharpening 106. The cross section of the sharpening 106 constitutes an edge cross section. The tube is arranged with fastening means 103 by way of a collar, by the aid of which the tube ido can be fastened on a container with a corresponding internal recess.

FIG. 2 shows the fastenings means of a container for a tube according to the present invention. The container 250 illustrated in FIG. 2 is the same container as the one illustrated in FIG. 1a. The container 250 is provided with a hole 252, which possesses dimensions corresponding to the external dimensions of a tube. The container 250 is besides provided with an internal recess 251 (illustrated with a dotted line), which corresponds to the collar on the tube. In FIG. 2 a pin 253 is besides illustrated, which constitutes a part of the container 250. The pin 253 ensures that a bar in the tube edges towards a contraction in the tube. In FIG. 2 a cavity 254 is besides illustrated (illustrated with a dotted line), through which the liquid can flow from the container 250 and out to the tube.

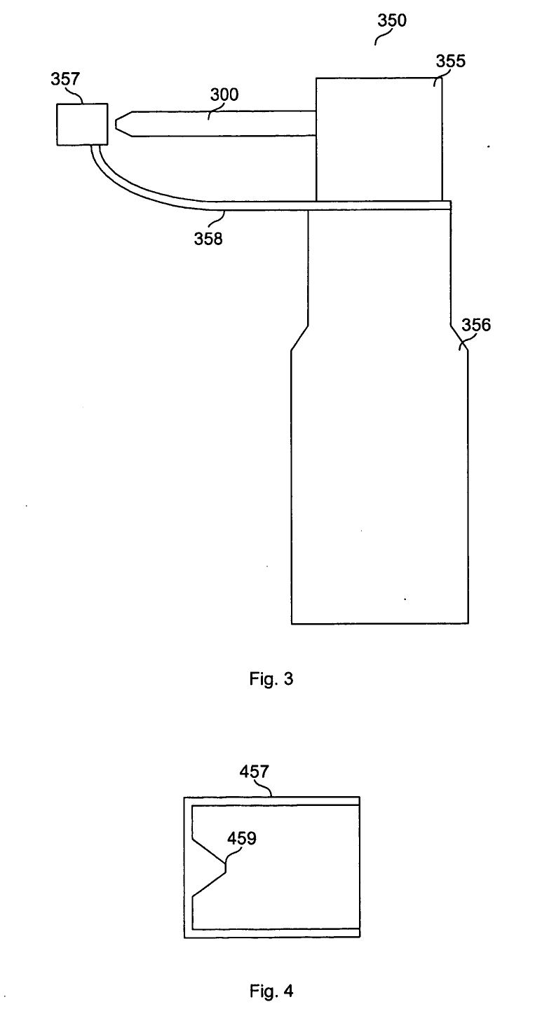

In FIG. 3 a container 350 with a tube 300 and a protective cap 357 according to the present invention are illustrated. The container 350 consists of an upper part 355, which contains a pump (not illustrated) and a lower part 356, which contains a liquid. The pump is activated by hand force by pressing the upper part 355 and the lower part 356 together. The protective cap 357 is fastened to the container 350 with a tape 358 ensuring that the protective cap does not disappear.

In FIG. 4 a protective cap 457 is illustrated. The protective cap 457 possesses covering means 459 by way of an internal projection adapted to contact with a tube. The covering means 459 can besides be coated with a barrier of silver ions and/or nanosilver particles.

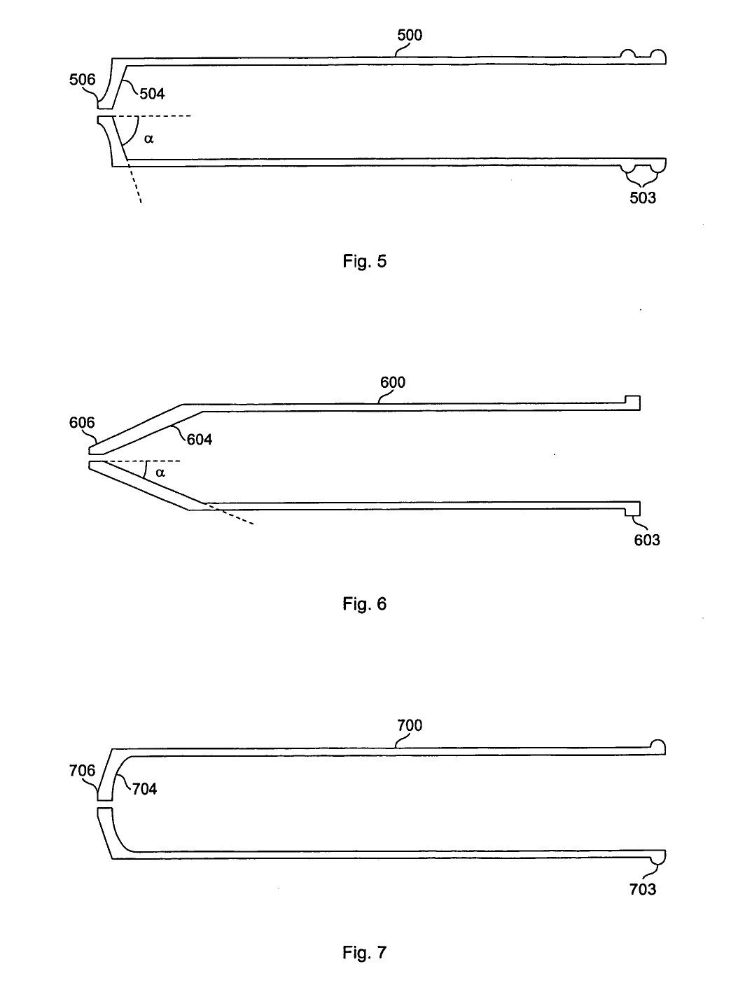

In FIG. 5 another embodiment of a tube 500 is illustrated. In this case only the tube 500 itself has been illustrated. The tube 500 is provided with fastening means 503 by way of a collar with two rings. The tube 500 is besides provided with a narrowing 504. A straight line parallel to the narrowing 504 possesses an angle α longitudinally to the tube, which is larger than 45 degrees and concurrently less than 90 degrees. The tube 500 is besides provided with a sharpening 506.

In FIG. 6 a third embodiment of a tube 600 is illustrated. In this case only the tube 600 itself has been illustrated. The tube 600 is provided with fastening means 603 by way of a collar with an angular ring. The tube 600 is besides provided with a narrowing 604. A straight line parallel to the narrowing 604 possesses an angle α longitudinally to the tube, which is less than 45 degrees. The tube 600 is besides provided with a sharpening 606.

In FIG. 7 a fourth embodiment of a tube 700 is illustrated. In this case only the tube 700 itself has been illustrated. The tube 700 is provided with fastening means 703 by way of a collar with a ring. The tube 700 is provided with a curved narrowing 704. The tube 700 is besides provided with a sharpening 706.

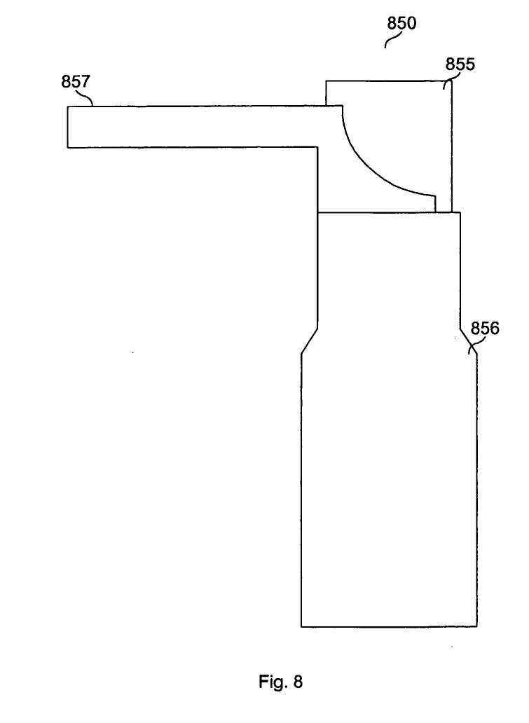

FIG. 8 shows a container 850 with a tube (not illustrated) according to the present invention and with an alternative protective cap 857 arranged on the tube, which is thereby covered by the protective cap 857. The container 850 consists of an upper part 855, which contains a pump (not illustrated) and a lower part 856, which contains a liquid. The pump is activated by hand force by pressing the upper part 855 and the lower part 856 together. The protective cap 857 is fastened to the container 850 by pushing the C-like shaped collar of the protective cap around the upper part 855 at the transition to the lower part 856. The protective cap 857 is thus held in position on the container 850 and at the same time blocks so as to prevent the upper part 855 and the lower part 856 from being pressed together. Thus unintended activation of the pump is prevented. This is a great advantage, for instance for a user carrying the container 850 in his pocket.

A first embodiment thus comprises fitting of a bar of a nonporous, elastic material inside the tube, so that it fills the tube longitudinally and concurrently possesses a diameter somewhat less than the internal diameter of the tube. The tube has been arranged, so that at the opening a non-vertical surface in relation to the longitude of the tube is formed (i.e. an internal narrowing, e.g. by way of a cone). The internal narrowing has been designed with the purpose of keeping the elastic bar in place and together with the elastic bar of forming a closing mechanism. The angle (α) and the elasticity of the bar together with the viscosity of the preparation determine the velocity, with which the preparation leaves the tube. The closing mechanism can accordingly be adapted to a given velocity for a given preparation when determining the angle (α) of the narrowing and when determining the elasticity of the bar. The closing mechanism functions by means of the power, with which the liquid leaves the valve inside the pump. The pressure from the liquid will compress the elastic material cross-sectionally and/or in a longitudinal direction, and the liquid is pressed out of the opening of the tube. When the pressure drops again, the elastic material will revert to its original shape and thereby close the hole. The closing mechanism applies an elastic material, which is resistant with respect to the microorganism's ability to adhere to the surface. The material can besides possess cast-in, active silver ions and/or nanosilver particles for greater safety.

FIG. 9a shows an alternative embodiment of the other end 902 of the tube seen from the side. The other end of the tube includes a narrowing 904 with a barrier part, which is constituted by a stiff core 906 fitted on the tube with fastening arms 918, core 906 edging towards an opening part, which is constituted by a cap 908 of an elastic material. The cap 908 is fitted across the narrowing and possesses an opening 910 with the same or less diameter as that of the core 906, so that the core blocks the opening 910 and thus penetration of impurities, e.g. bacteria, is avoided. The mentioned barrier effect is further enhanced by the application of an elastic material in the cap, so that the edge of the cap 908 presses against the edge on the core 906.

When a pump (not shown) is activated, the liquid is pumped out into the tube 902 into the clearance between the tube 902 and the bar 906. Where the bar 906 edges towards the cap 908 the liquid pressure will press the cap 908, so that the cap is deformed and thereby bears down, so that the liquid can pass further on out into the opening. When the pump is thereafter deactivated, the edge towards the cap 908 will again edge towards the edge on the core 906, thus blocking for liquid flow and impurities. On the figure the core 906 projects further than the tube 904, this will entail that a cavity 912 is formed between the cap 908 and the tube 904. The mentioned difference in length entails that after the fluid pressure a suction will occur and any remaining liquid on the tip 914 of the cap will be sucked back into the tube.

In FIG. 9b the tube 904 is seen from the end, where no cap 908 is arranged, and it is illustrated how the core 906 has been fastened to the inside of the tube by means of fastening arms 918. The core 906 can for instance be cast together with the tube 904.

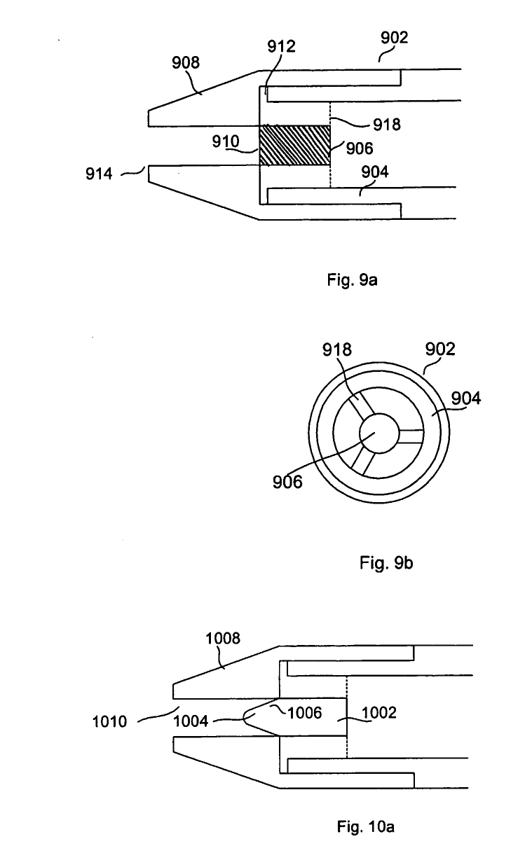

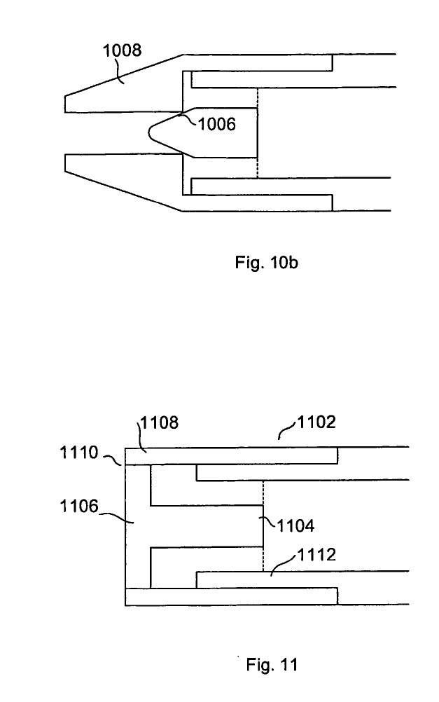

In FIGS. 10a and 10b an embodiment of the core 1002 is illustrate, in which a conical end 1004 has been arranged, so that an oblique side 1006 is formed, which edges towards the edge of the cap. In the FIG. 10a the core 1002 and the cap 1008 have been formed, so that the opening 1010 possesses the same diameter as that of the core 1002, whereby the edge on the cap 1008 edges towards the root of the core sharpening. In FIG. 10b an example is illustrated, in which the oblique side 1006 itself edges towards the edge of the cap 1008, this is obtained by letting the diameter of the opening remain smaller than that of the core.

In FIG. 11 another embodiment of the other end 1102 of the tube is illustrated, here the core 1104 has the shape of a plate in the one end, where the plate 1106 has a larger diameter than that of the core 1104. The plate 1106 has been designed with the same dimensions as those of the opening in the cap 1108, so that this blocks for the opening 1110 in the cap. The cap 1108 can for example consist of a flexible plastic tube, which is fitted around the plate 1106 and the narrowing 1112. In case liquid is pressed out towards the opening 1110, the pressure will entail that the tube is deformed, and the liquid can penetrate through the opening 1110 between the plate and the tube.

The invention is further illustrated in the following examples, which, however, are not intended to limit the same.

### EXAMPLES

### Example 1

Agar Plate Testing with Pseudomonas aeroginosa

Test Containers:

Three containers with tubes according to the invention as presented above without silver ions and nanosilver particles in the tubes (containers filled with sterile water).
   Kᵢ
   K₂
   K₃
Six containers with tubes according to the invention as presented above with silver ions and/or nanosilver particles in the tubes (containers filled with sterile water).
   Ag₁
   Ag₂
   Ag₃
   Ag₄
   Ag₅
   Ag₆

All tubes of the nine containers were inoculated for contamination for 3 min with Pseudomonas aeroginosa in 1.5 ml Eppendorf tubes with 1×10⁵ cells/ml. Thereafter the tubes were dipped for 10 sec in 1×PBS (phosphate buffered saline) solution for washing.

Six drops from K₁, Ag₁ and Ag₂ were dropped at time zero (T₀) on TSB agar plates, plated and incubated at 28° C. The rest of the containers were placed in 100 ml sterile Duran bottles filled with 5 ml sterile 1×PBS and were incubated at 28° C.

After 4 hours (T₄) six drops from K₂, Ag₃ and Ag₄ were dropped on TSB agar plates, plated and incubated at 28° C. and after 6 hours (T₆) the same procedure was repeated for K₃, Ag₅ and Ag₆.

After incubation of all plates for 65 hours the plates were counted for CFU. CFU counts for all bottles are shown in table 1.

TABLE 1

| Bottle | CFU |
|---|---|
| K₁ (T₀) | >1000 |
| K₂ (T₄) | 25 |
| K₃ (T₆) | 0 |
| Ag₁ (T₀) | 110 |
| Ag₃ (T₄) | 0 |
| Ag₅ (T₆) | 0 |
| Ag₂ (T₀) | 205 |
| Ag₄ (T₄) | 0 |
| Ag₆ (T₆) | 0 |

From the table it can be seen that the bacteria from the containers with tubes comprising silver ions and/or nanosilver particles are killed after 4 hours and 6 hours and that also the bacteria from the containers with tubes without silver ions and nanosilver particles are totally killed after 6 hours and almost killed after 4 hours. The results in the table also clearly demonstrate that the CFU counts at the start of the test are much lower when using tubes comprising silver ions and/or nanosilver particles according to the invention than for tubes without silver ions and nanosilver particles according to the invention.

### Example 2

Agar Plate Testing with Staphylococcus epidermidis

Three containers with tubes according to the invention as presented above without silver ions and nanosilver particles in the tubes (containers filled with sterile water).
   K₁
   K₂
   K₃
Six containers with tubes according to the invention as presented above with silver ions and/or nanosilver particles in the tubes (containers filled with sterile water).
   Ag₁
   Ag₂
   Ag₃
   Ag₄
   Ag₅
   Ag₆

All tubes of the nine containers were inoculated for 10 min with Staphylococcus epidermidis (9142) in a micro plate with 1×10⁶ cells/ml (200 μl/well) for contamination. Thereafter the tubes were washed once during 2 min in 1×PBS in a micro plate with 200 μl/well, followed by washing twice during 2 min in 1×PBS/Tween 20 in a micro plate with 200 μl/well, followed by washing twice during 2 min in 1×PBS in a micro plate with 200 μl/well.

Six drops from container K₁, Ag₁ and Ag₄ were dropped at time zero (T₀) on TSB agar plates, plated and incubated at 37° C. The rest of the containers were placed in 100 ml sterile Duran bottles filled with 5 ml sterile 1×PBS and were incubated at 37° C.

After 4 hours (T₄) six drops from container K₂, Ag₂ and Ag₅ were dropped on TSB agar plates, plated and incubated at 37° C. and after 6 hours (T₆) the same procedure was repeated for container K₃, Ag₃ and Ag₆.

After incubation of all plates for 12 hours the plates were counted for CFU. CFU counts for all bottles are shown in table 2.

TABLE 2

| Bottle | CFU |
|---|---|
| K₁ (T₀) | 805 |
| K₂ (T₄) | 1 |
| K₃ (T₆) | 0 |
| Ag₁ (T₀) | 147 |
| Ag₂ (T₄) | 0 |
| Ag₃ (T₆) | 0 |
| Ag₄ (T₀) | 18 |
| Ag₅ (T₄) | 0 |
| Ag₆ (T₆) | 0 |

From the table it can be seen that this test also verifies the function of the container and tube according to the invention.

### Example 3

Spectramax Testing with Staphylococcus epidermidis

1. A: tube according to the invention without Nanosilver BG™ (control).
2. A-D: tubes (4 samples) according to the invention with Nanosilver BG™.
3. A: positive control (standard silicone polymer from Bio-Gate, polymer with Nanosilver BG™).
3. B: negative control (standard silicone polymer from Bio-Gate, same polymer as 3A but without Nanosilver BG™).
3. C: blank.
4. A-D: media only (control for sterility)

Assay was performed according to Bechert et al., Nature Medicine Vol. 9, September 2000. Contamination with bacteria was with 500.000 cells/tube. Incubation was performed in minimal medium for 24 hours.

The proliferation assay reflected high antibacterial activity for the tubes with nanosilver particles according to the invention. The killing rate was 100% (bactericidal).

The general idea is thus that the end of the tube includes an opening part and a barrier part, respectively, where the barrier part edges towards the opening part, so that this will block the opening in the opening part. By at least forming the barrier part or the opening part in a flexible material, the pressing out of the liquid through the opening passing the barrier part is enabled. This happens after a deformation of at least the barrier part or the opening part. The design of the opening part and the barrier part, respectively, and the elasticity of the material will together with the viscosity of the preparation determine the velocity, with which the preparation leaves the tube. The closing mechanism can therefore be adapted to a given velocity for a given preparation. The closing mechanism functions by means of the force, with which the liquid leaves the valve inside the pump. The pressure from the liquid will cause deformation of the elastic material, so that the liquid can be pressed out of the opening of the tube. When the pressure falls again, the elastic material will revert to its original shape and the barrier part will block the opening in the opening part. The closing mechanism applies an elastic material, which is resistant with respect to microorganisms' ability to adhere on the surface. The material can besides be provided with cast in active silver ions and/or nanosilver particles for greater safety.

1. A tube for use with a container with a built-in pump, the tube comprising:
an internal cross section of the tube for flow of a liquid;
an external cross section of the tube, which is larger than the internal cross section;
a first end with a first opening for intake of the liquid, the first end including a fastening means for fastening the tube to the container; and
a second end, with an opening part, which includes a second opening for discharge of the liquid,
wherein the second end further comprises a barrier part that projects towards the opening part to block the second opening, wherein at least one of the barrier part and the opening part is an elastic material, deformable by a pressure applied thereto, so that the liquid can be pressed out through the second opening upon deformation of at least one of the barrier part and the opening part.

2. A tube according to claim 1, the second opening further comprising an opening cross section which is smaller than the internal cross section; and
wherein the barrier part is a bar of a flexible material, the bar being arranged in the internal cross section of the tube.

3. A tube according to claim 2, the opening part at the second end further comprising a narrowing section, the narrowing section gradually narrowing in an axial direction from the internal cross section the opening cross section.

4. A tube according to claim 3, wherein the narrowing section has a surface, and an angle is located between a straight line parallel to the surface of the narrowing section and a longitudinal axis of the tube, the angle being less than 90 degrees.

5. A tube according to claims 2, 3, or 4, wherein the opening part at the second end further comprises a sharpening of the tube, the sharpening of the tube forming an edge cross section, the edge cross section being smaller than the external cross section of the tube, and the edge cross section being larger than the opening cross section of the second opening.

6. A tube according to claim 1 wherein the elastic material is non-reactive with respect to the liquid.

7. A tube according to claim 1 wherein the opening part in the second end further comprises a bacteriological barrier, the bacteriological barrier comprising at least one of silver ions and nanosilver particles.

8. A tube according to claim 1, the tube further comprising a protective cap adapted for fitting on the tube, the protective cap being provided with a covering means for covering of the second opening.

9. A tube according to claim 8, wherein the covering means further comprises a bacteriological barrier, the bacteriological barrier comprising at least one of silver ions and nanosilver particles.

10. A container with a built-in pump, in which the container is combined with a tube according to claim 1, the tube being integral with the container.

11. A method of using the container according to claim 10, the container adapted for dispensing an ophthalmic compositions in an eye.

12. The method of claim 11, the container being held in a vertical position while dispensing the ophthalmic composition so that a drop of the ophthalmic composition enters the eye in a horizontal direction.
